(19) United States
(12) Patent Application Publication
(10) Pub. No.: US 2025/0377308 A1
(43) Pub. Date: Dec. 11, 2025

(54) IMPLEMENTING OBLIQUE VIEW IMAGING SYSTEMS FOR DIE BONDING INSPECTION

(71) Applicant: UNIVERSITY OF MASSACHUSETTS, Westborough, MA (US)

(72) Inventors: Rui Ma, Amherst, MA (US); Xian Du, Amherst, MA (US)

(21) Appl. No.: 19/233,677

(22) Filed: Jun. 10, 2025

Related U.S. Application Data
(60) Provisional application No. 63/657,999, filed on Jun. 10, 2024.

(51) Int. Cl. G01N 21/88; G01N 21/95; G01N 21/956

(52) U.S. Cl. CPC G01N 21/8851; G01N 21/9503; G01N 21/95684; G01N 2201/11

(57) ABSTRACT

Various examples are provided related to oblique view imaging for die bonding inspection. In one example, a method includes obtaining an oblique view image of a die on an inspection stage in an XOY plane, the image obtained at an angle with respect to the die; generating a top view image in the XOY plane by projecting the oblique view image using a projection matrix based upon top view and oblique view intrinsic parameters; and determining positions of fiducial markers in the projected top view image. In another example, a method includes obtaining an oblique view image of a die on an inspection stage in an XOY plane; generating a side view image in a YOZ plane or an XOZ plane by projecting the oblique view image using a projection matrix based upon side view and oblique view intrinsic parameters; and determining positions of fiducial markers.

### CROSS REFERENCE TO RELATED APPLICATIONS

This application claims priority to, and the benefit of, U.S. provisional application entitled “Implementing Oblique View Imaging Systems for Die Bonding Inspection” having Ser. No. 63/657,999, filed Jun. 10, 2024, which is hereby incorporated by reference in its entirety.

### BACKGROUND

In die-bonding processes, micron- or submicron-scale patterns on dies or substrates are conventionally inspected vertically over millimeter-scale areas. However, the microelectronics and die shape or geometry information in the depth along the top-down direction cannot be distinctively detected from a top-down view. Additionally, the imaging systems may not always accommodate the top-view due to spatial constraints, such as the motion path of the robotic arm occupying the necessary space. Therefore, exploring the potential of an oblique view imaging system is worthwhile.

### SUMMARY

Aspects of the present disclosure are related to oblique view imaging for die bonding inspection. In one aspect, among others, a method for oblique view imaging inspection comprises obtaining an oblique view image of a die on an inspection stage in an XOY plane, the image obtained at an angle with respect to the die; generating a top view image in the XOY plane by projecting the oblique view image using a projection matrix based upon top view and oblique view intrinsic parameters; and determining positions of fiducial markers in the projected top view image. In one or more aspects, the projection matrix can comprise a rotation matrix and a translation vector. The projection matrix can translate a pixel of the oblique view image to a pixel of the projected top view image. The pixel of the projected top view image can be derived as

$${x}_{t o p} = K {R}_{t o p} {R}_{oblique}^{- 1} {K}^{- 1} {x}_{oblique} - K ( {t}_{top} - {R}_{t o p} {R}_{oblique}^{- 1} {t}_{oblique} ) .$$

In various aspects, the positions of the fiducial markers can be determined by a registration algorithm. The method can comprise determining fiducial marker position errors based upon the determined positions and a fiducial marker template. The method can comprise performing position correction based upon the fiducial marker position errors. The fiducial marker template can be from a higher resolution image system. The method can comprise positioning the die on the inspection stage. The die can be a circuit die.

In another aspect, a method for oblique view imaging inspection comprises obtaining an oblique view image of a die on an inspection stage in an XOY plane, the image obtained at an angle with respect to the die; generating a side view image in a YOZ plane or an XOZ plane by projecting the oblique view image using a projection matrix based upon side view and oblique view intrinsic parameters; and determining positions of fiducial markers in the projected side view image. In one or more aspects, the projection matrix can comprise a rotation matrix and a translation vector. The projection matrix can translate a pixel of the oblique view image to a pixel of the projected top view image. The oblique view image can be taken at a corner of the die. Generating the side view image can comprise generating side view images in both the YOZ plane and the XOZ plane by projecting the oblique view image using corresponding projection matrices. In various aspects, the positions of the fiducial markers can be determined by a registration algorithm. The method can comprise determining fiducial marker position errors based upon the determined positions and a fiducial marker template. The method can comprise performing position correction based upon the fiducial marker position errors. The method can comprise positioning the die on the inspection stage. The die can be a circuit die.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates examples of top view and oblique view imaging systems, in accordance with various embodiments of the present disclosure.

FIG. 2A illustrates an example of an oblique view imaging system with tilted target, in accordance with various embodiments of the present disclosure.

FIG. 2B includes images of aligned and tilted stacking dies taken with oblique view cameras, in accordance with various embodiments of the present disclosure.

FIG. 3 illustrates an example of workflow of an XOY plane inspection process, in accordance with various embodiments of the present disclosure.

FIG. 4 illustrates an example of a circuit die with position error, in accordance with various embodiments of the present disclosure.

FIG. 5 illustrates examples of pairs of oblique view images and XOY and YOZ projected images, in accordance with various embodiments of the present disclosure.

FIG. 6 illustrates an example of an oblique view image facing a corner of the stacked dies, in accordance with various embodiments of the present disclosure.

FIG. 7 illustrates examples of oblique view images taken from different working distances, in accordance with various embodiments of the present disclosure.

FIG. 8 is a schematic block diagram illustrating an example of a computing device that can be used for implementation of an oblique view imaging system for die bonding inspection, in accordance with various embodiments of the present disclosure.

### DETAILED DESCRIPTION

Disclosed herein are various examples related to oblique view imaging for die bonding inspection. Reference will now be made in detail to the description of the embodiments as illustrated in the drawings, wherein like reference numbers indicate like parts throughout the several views.

A comprehensive solution is proposed for an inspection system with an oblique view imaging setup. Initially, it is demonstrated that the oblique view can achieve similar performance to that of a top view. Subsequently, oblique imaging can be used to infer perpendicularity, parallelism, and positional variations, which are important for evaluating and controlling pick-and-placement alignment, without missing top-view information.

### Method and Experimental Results

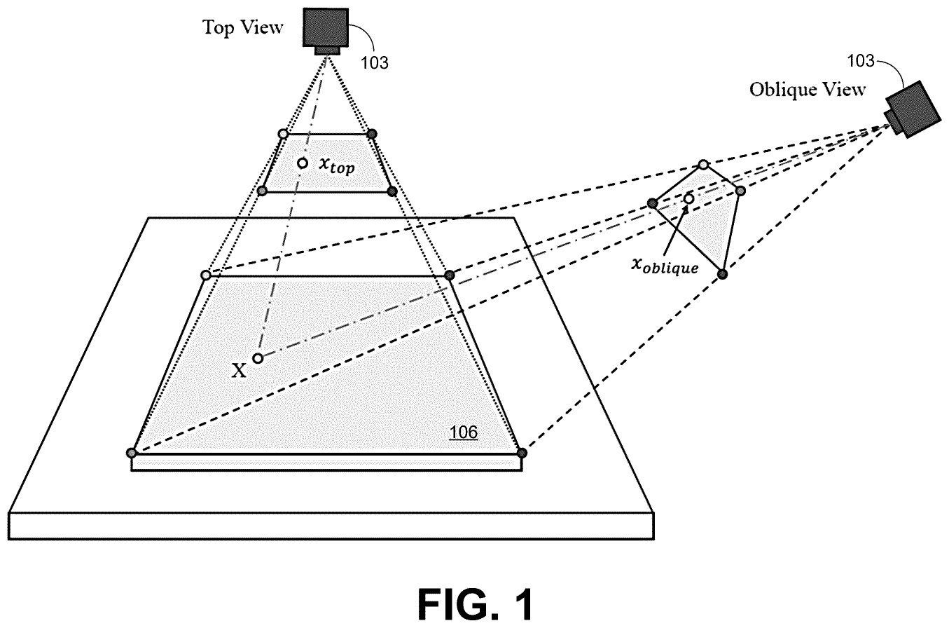

Referring to FIG. 1, shown is a geometric schematic illustrating examples of both top view and oblique view imaging with imaging systems including the imaging device (e.g., camera) 103 positioned over, e.g., a circuit die 106 and at an oblique angle with respect to the circuit die 106. Based on the geometric relationship between the two systems, the images can be projected from the oblique view to the top view. The detailed process is derived below using Epipolar Geometry. Assuming that the same imaging system is used for both views, let K denote the intrinsic parameters of the top view and oblique view imaging system, Rₜₒₚ, tₜₒₚ denote the rotation matrix and translation vector of the top view imaging system, and R_{oblique}, t_{oblique} denote the rotation matrix and translation vector of the oblique view imaging system. The projection matrices for both views can be represented as:

$${P}_{top} = K [ {R}_{t o p} \vert {t}_{t o p} ] , {P}_{oblique} = K [ {R}_{oblique} \vert {t}_{oblique} ] . \qquad ( 1 )$$

Assume an arbitrary point X at the object planar, as shown in FIG. 1, Let xₜₒₚ and x_{oblique} be the projected points on the imaging planes. These can be calculated by the projection matrices as follows:

$${x}_{top} = {P}_{top} X , {x}_{oblique} = {P}_{oblique} X . \qquad ( 2 )$$

Let the vector X be represented as [X1, X2, X3,1]^{T}. Then, xₜₒₚ can be expressed using x_{oblique} and the intrinsic and extrinsic parameters of the imaging systems. Rewriting equation (2) gives:

$${x}_{top} = {P}_{top} X \to {K}^{- 1} {x}_{top} = {R}_{top} [ \begin{matrix}{X}_{1} \\ {X}_{2} \\ {X}_{3}\end{matrix} ] + {t}_{top} , \qquad ( 3 )$$

$${x}_{oblique} = {P}_{oblique} X \to {K}^{- 1} {x}_{oblique} = {R}_{oblique} [ \begin{matrix}{X}_{1} \\ {X}_{2} \\ {X}_{3}\end{matrix} ] + {t}_{oblique} .$$

From equations (3), xₜₒₚ can be derived as:

$${x}_{top} = {KR}_{top} {R}_{oblique}^{- 1} {K}^{- 1} {x}_{oblique} - K ( {t}_{t o p} - {R}_{top} {R}_{oblique}^{- 1} {t}_{oblique} ) . \qquad ( 4 )$$

Therefore, the pixels in the oblique view image can be projected into the top view image using equation (4). This proves that the image from the oblique view can provide similar quality to the top view utilizing this transformation equation.

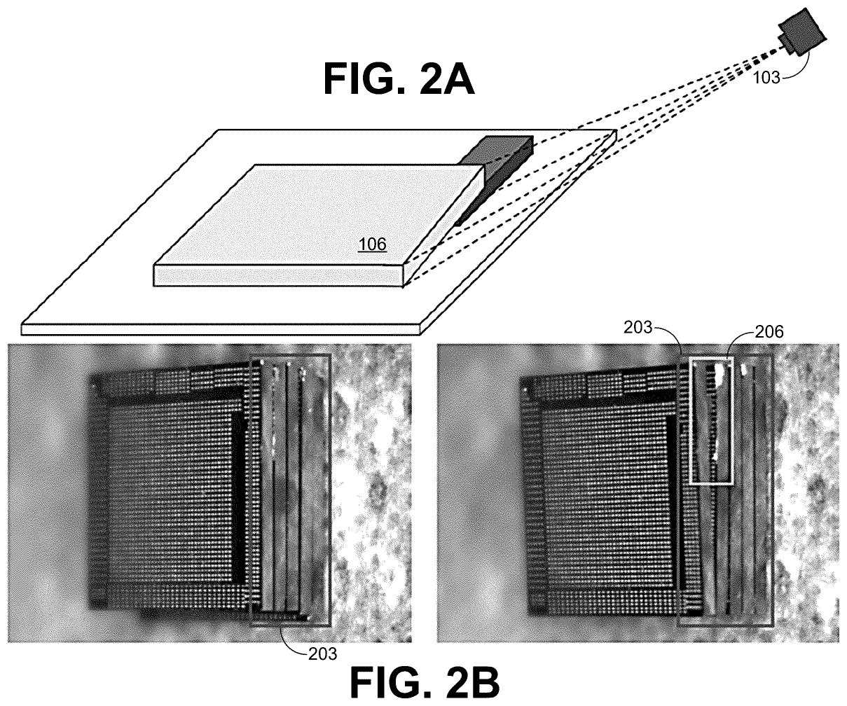

After proving the image quality of oblique view images, the third dimension information can be leveraged. FIG. 2A shows a schematic diagram of an oblique view imaging system viewing a tilted die plane. FIG. 2B shows two real-world stacking dies images taken by the oblique view imaging system. The left image is without tilting (aligned stacking dies), and the right image is with a tilt (tilted stacking dies). The oblique view imaging system can detect this tilt, capturing the third dimension, as indicated by the larger block outlines 203. The highlighted block outline 206 on the right bottom highlights the tilted part, which is easily observable. More details related to the inspection process will now be explained in each side view based on the oblique view images.

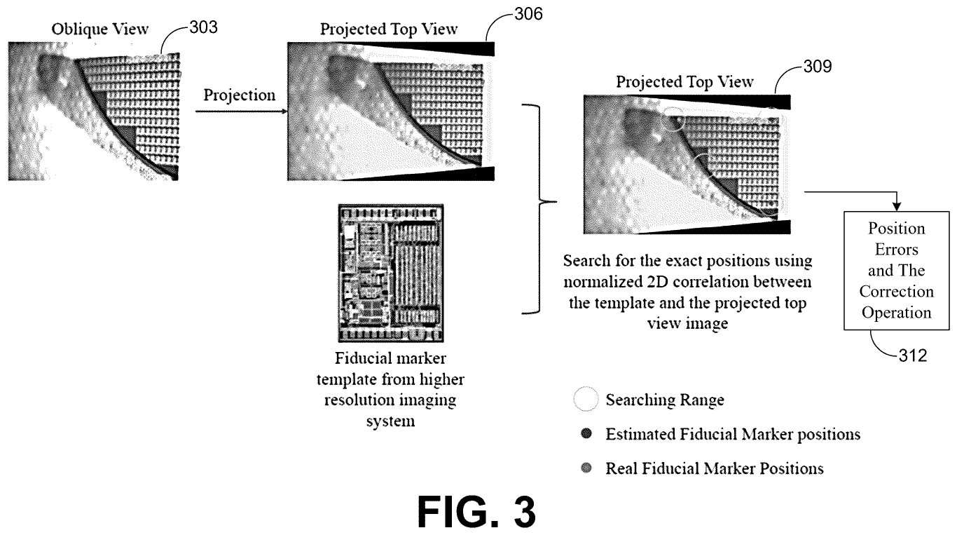

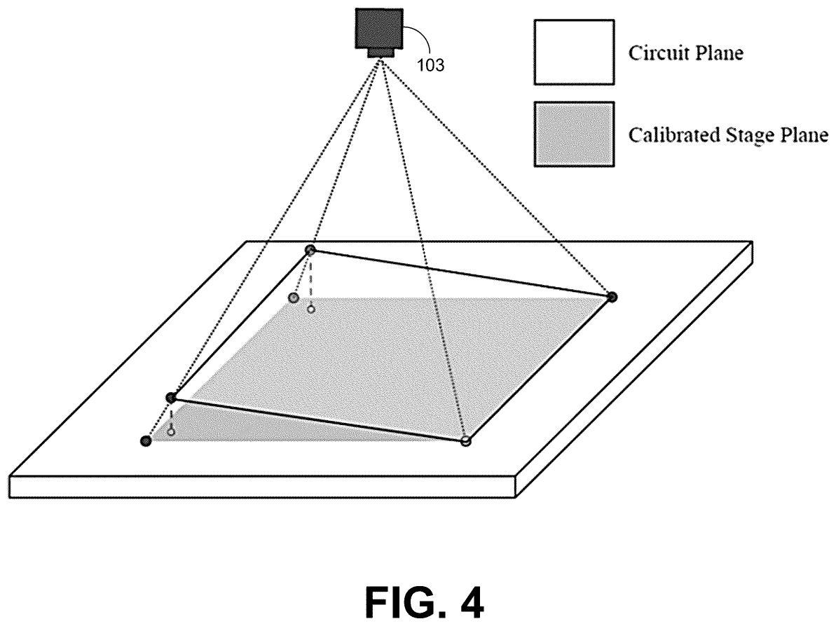

Top view inspection: Referring to FIG. 3, shown is an example of an inspection process workflow for the XOY plane. The steps can include:
Initially, the imaging system will be calibrated to obtain the extrinsic parameters relative to the inspection stage.
A circuit die can be placed on the inspection stage and an oblique view image can be captured by the imaging system as shown at 303.
Based on the calibration parameters, a top view image can be achieved by projection from the oblique view image at 306. The predefined fiducial markers' positions can be determined from the projected top view image at 309.
The circuit die may not be perfectly aligned with the inspection stage. Therefore, one or more image registration algorithm can be used to locate the exact positions of fiducial markers on the projected top view image at 309. Based on the accurate and estimated positions, the position error of the circuit die can be calculated, and position correction can be performed at 312.
Assuming the inspection stage is a horizontal plane, as shown in FIG. 4, if the fiducial markers are found at different positions, the angular errors of the circuit die plane can be calculated based on the geometric constraints.
Detailed measurements can then take place.

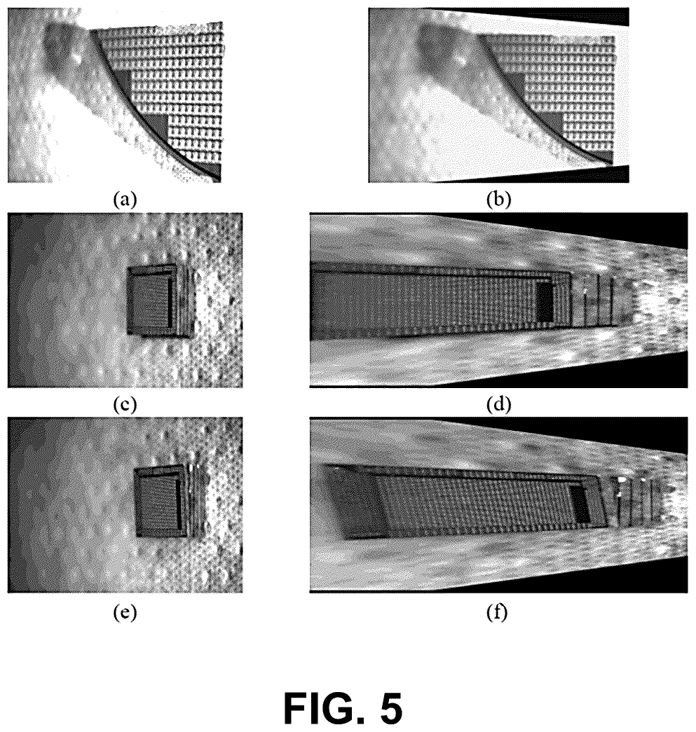

Side view inspection: Similarly, the oblique view images can be projected into the side view to focus on the information in the YOZ plane. By applying the same process, after the position correction, the misalignment between different layers of circuit dies can be eliminated, improving the efficiency of the die stacking process.
Initially, the imaging system will be calibrated to obtain the extrinsic parameters relative to the inspection stage.
A circuit die can be placed on the inspection stage and an oblique view image can be captured by the imaging system.
Based on the calibration parameters, a side view image can be achieved by projection from the oblique view image. Predefined fiducial markers' positions can be determined from the projected side view image.
The circuit die may not be perfectly aligned with the inspection stage. Therefore, one or more image registration algorithm can be used to locate the exact positions of fiducial markers on the projected side view image. Based on the accurate and estimated positions, the position error of the circuit die can be calculated, and position correction can be performed.
If the fiducial markers are found at different positions, the angular errors of the circuit die plane can be calculated based on the geometric constraints.
Detailed measurements can then take place.
   FIG. 5 shows some examples of the images from the oblique view and the projected image results from XOY and YOZ planes. Image (a) is a diced wafer from an oblique view and image (b) is the XOY projected image of image (a). Image (c) shows an aligned stacking of dies from an oblique view and image (d) is the YOZ projected image of image (c). Image (e) shows a tilted stacking of dies from an oblique view and image (f) is the YOZ projected image of image (e).

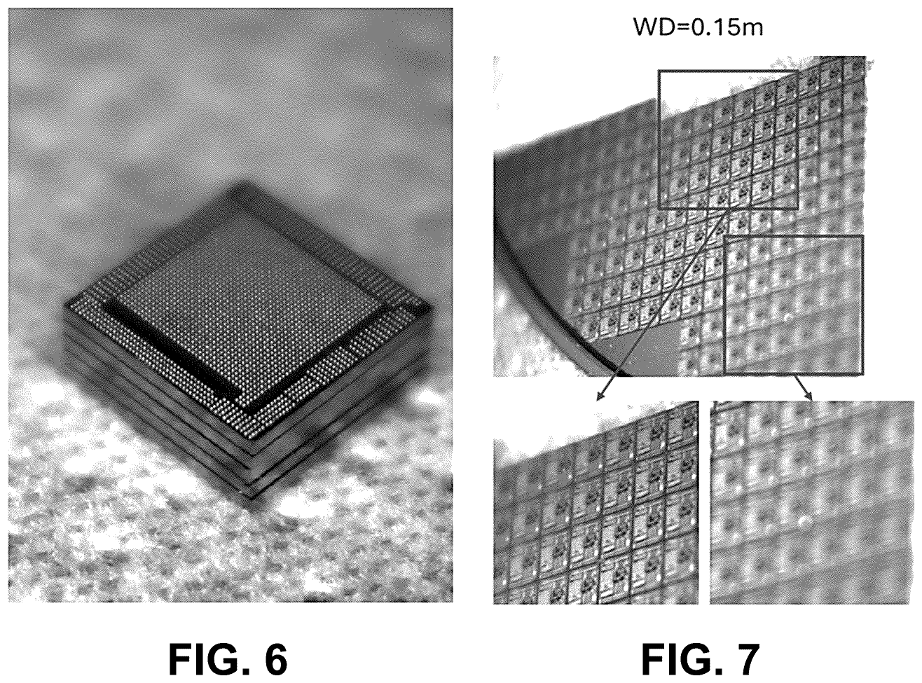

Corner view inspection: Furthermore, if the imaging system faces the corner of the circuit dies as shown in FIG. 6, the information on the XOZ plane can also be included in the projected images. The same inspection process can be applied to correct the misalignment on the XOZ plane.

All these inspection processes on the different planes (XOY, YOZ and/or XOZ) can run in parallel since the projected view images, fiducial marker position determination and error correction can share the oblique view image captured by the imaging system.

### Mitigating Out-of-Focus Problem

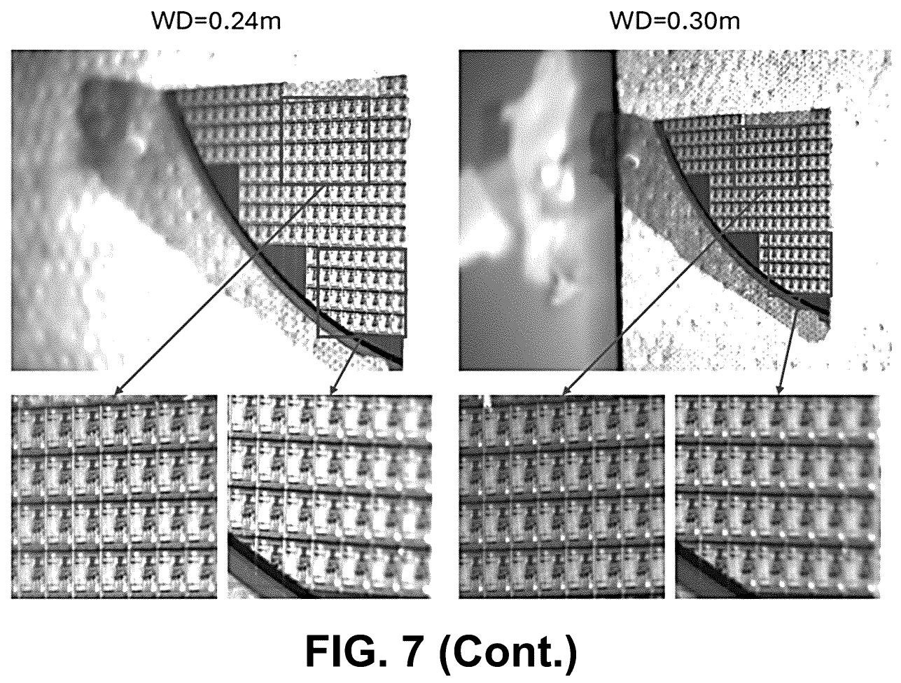

The oblique view imaging system has some disadvantages. One disadvantage is the limited focused range caused by the depth of field constraints of the imaging system. FIG. 7 shows examples of sample images taken from a 45-degree oblique view camera. Increasing the working distance mitigates the out-of-focus problem by increasing the depth of field. However, images taken from a longer working distance lose some detailed information, such as the texture of the circuit. A Hardware-Aware Super-Resolution (HASR) algorithm offers an optimal solution for enhancing these images. U.S. provisional application entitled “Hardware-Aware Network for Real-World Single Image Super-Resolutions” having Ser. No. 63/658,001, filed Jun. 10, 2024, which is hereby incorporated by reference in its entirety, discloses HASR algorithms for image resolution enhancement. Using multiple imaging systems at different positions can also address the out-of-focus problem at shorter working distances. Each imaging system can focus on a different part of the field of view (FOV). Image registration and stitching algorithms as described in “Closed-loop feedback registration for consecutive images of moving flexible targets” by R. Ma and X. Du (Applied Intelligence, pp. 1-21, August 2022) can be applied to the images taken from multiple positions. Additionally, multi-frame image super-resolution algorithms as described in “Deep Reparametrization of Multi-Frame Super-Resolution and Denoising” by G. Bhat et al. (2021 IEEE/CVF International Conference on Computer Vision (ICCV), Montreal, QC, Canada, October 2021, pp. 2440-2450) and “A new denoising model for multi-frame super-resolution image reconstruction” by I. E. Mourabit et al. (Signal Processing, vol. 132, pp. 51-65, March 2017) can enhance the quality of these images.

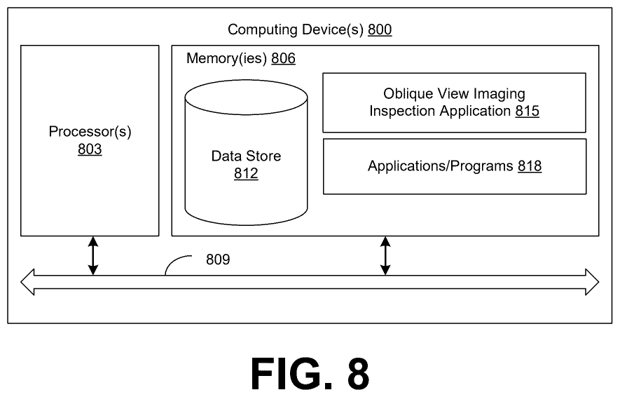

With reference next to FIG. 8, shown is a schematic block diagram of a computing device 800. In some embodiments, among others, the computing device 800 may represent one or more computing devices (e.g. a smartphone, tablet, computer, etc.). Each computing device 800 includes at least one processor circuit, for example, having a processor 803 and a memory 806, both of which are coupled to a local interface 809. To this end, each computing device 800 may comprise, for example, at least one server computer or like device, which can be utilized in a cloud-based environment. The local interface 809 may comprise, for example, a data bus with an accompanying address/control bus or other bus structure as can be appreciated. The local interface 809 can facilitate communication with an imaging device (e.g., camera, etc.) that is used to capture images of the circuit die for processing.

In some embodiments, the computing device 800 can include one or more network interfaces. The network interface may comprise, for example, a wireless transmitter, a wireless transceiver, and/or a wireless receiver (e.g., Bluetooth®, Wi-Fi, Ethernet, etc.). The network interface can communicate with a remote computing device using an appropriate communications protocol. As one skilled in the art can appreciate, other wireless protocols may be used in the various embodiments of the present disclosure.

Stored in the memory 806 are both data and several components that are executable by the processor 803. In particular, stored in the memory 806 and executable by the processor 803 are at least one oblique view imaging inspection application 815 and potentially other applications and/or programs 818. Also stored in the memory 806 may be a data store 812 and other data. In addition, an operating system may be stored in the memory 806 and executable by the processor 803.

It is understood that there may be other applications that are stored in the memory 806 and are executable by the processor 803 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 806 and are executable by the processor 803. In this respect, the term “executable” means a program or application file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and/or multiple processor cores and the memory 806 may represent multiple memories 806 that operate in parallel processing circuits, respectively, such as multicore systems, FPGAs, GPUs, GPGPUs, spatially distributed computing systems (e.g., connected via the cloud and/or Internet). In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the oblique view imaging inspection application 815 and other applications/programs 818, described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the oblique view imaging inspection application 815 and other applications/programs 818, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the oblique view imaging inspection application 815 and other applications/programs 818, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 800, or in multiple computing devices in the same computing environment. Additionally, it is understood that terms such as “application,” “service,” “system,” “engine,” “module,” and so on may be interchangeable and are not intended to be limiting.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for oblique view imaging inspection, comprising:
obtaining an oblique view image of a die on an inspection stage in an XOY plane,
the image obtained at an angle with respect to the die;
generating a top view image in the XOY plane by projecting the oblique view image using a projection matrix based upon top view and oblique view intrinsic parameters; and
determining positions of fiducial markers in the projected top view image.

2. The method of claim 1, wherein the projection matrix comprises a rotation matrix and a translation vector.

3. The method of claim 2, wherein the projection matrix translates a pixel of the oblique view image to a pixel of the projected top view image.

4. The method of claim 3, wherein the pixel of the projected top view image is derived as:
$${x}_{top} = {KR}_{top} {R}_{oblique}^{- 1} {K}^{- 1} {x}_{o b l i q u e} - K ( {t}_{t o p} - {R}_{t o p} {R}_{oblique}^{- 1} {t}_{oblique} ) .$$

5. The method of claim 1, wherein the positions of the fiducial markers are determined by a registration algorithm.

6. The method of claim 5, comprising determining fiducial marker position errors based upon the determined positions and a fiducial marker template.

7. The method of claim 6, comprising performing position correction based upon the fiducial marker position errors.

8. The method of claim 6, wherein the fiducial marker template is from a higher resolution image system.

9. The method of claim 1, comprising positioning the die on the inspection stage.

10. The method of claim 1, wherein the die is a circuit die.

11. A method for oblique view imaging inspection, comprising:
obtaining an oblique view image of a die on an inspection stage in an XOY plane,
the image obtained at an angle with respect to the die;
generating a side view image in a YOZ plane or an XOZ plane by projecting the oblique view image using a projection matrix based upon side view and oblique view intrinsic parameters; and
determining positions of fiducial markers in the projected side view image.

12. The method of claim 11, wherein the projection matrix comprises a rotation matrix and a translation vector.

13. The method of claim 12, wherein the projection matrix translates a pixel of the oblique view image to a pixel of the projected side view image.

14. The method of claim 11, wherein the oblique view image is taken at a corner of the die.

15. The method of claim 14, wherein generating the side view image comprises generating side view images in both the YOZ plane and the XOZ plane by projecting the oblique view image using corresponding projection matrices.

16. The method of claim 11, wherein the positions of the fiducial markers are determined by a registration algorithm.

17. The method of claim 16, comprising determining fiducial marker position errors based upon the determined positions and a fiducial marker template.

18. The method of claim 17, comprising performing position correction based upon the fiducial marker position errors.

19. The method of claim 11, comprising positioning the die on the inspection stage.

20. The method of claim 11, wherein the die is a circuit die.
